(19) United States
(12) Patent Application Publication
(10) Pub. No.: US 2008/0011491 A1
(43) Pub. Date: Jan. 17, 2008

(54) Sprinkler having non-round exit orifice

(75) Inventors: Lawrence W. Thau, Flemington, NJ (US); William J. Reilly, Langhorne, PA (US); Stephen R. Ide, Nazareth, PA (US); Thomas F. Wancho, Bethlehem, PA (US); Robert J. Ballard, Whitehall, PA (US)

Correspondence Address: SYNNESTVEDT & LECHNER, LLP, 1101 MARKET STREET, 26TH FLOOR, PHILADELPHIA, PA, 19107-2950, US

(73) Assignee: Victaulic Company of America, Easton, PA (US)

(21) Appl. No.: 11/209,019

(22) Filed: Aug. 22, 2005

(51) Int. Cl. A62C 37/08

(52) U.S. Cl. 169/37; 239/498; 239/504; 239/601; 239/597

(57) ABSTRACT

A sprinkler for fire suppression systems that produces an orthogonal spray pattern is disclosed. The sprinkler has an exit orifice with a non-round perimeter and a deflector plate having a non-round perimeter. The shape of the deflector plate perimeter may be matched to that of the exit orifice perimeter. Orifice perimeters may be square, rectangular, formed of lobes or interconnected curves, and there may be multiple orifices in the sprinkler.

### FIELD OF THE INVENTION

This invention concerns sprinklers having exit orifices with non-round perimeters for producing orthogonal spray patterns.

### BACKGROUND OF THE INVENTION

Sprinklers according to the prior art, used in fire suppression systems in buildings such as offices, warehouses, hotels and the like, have a round exit orifice and a round deflector plate positioned in spaced relation to the exit orifice. The sprinklers, mounted in ceilings in rooms throughout the building, are connected to a piping network that supplies pressurized water. The sprinklers are closed by a thermally activated trigger. When such a sprinkler is opened as a result of a fire condition, water is discharged from the sprinkler in a round spray pattern produced by water flowing through the round orifice and impinging on the round deflector plate.

While such sprinklers are effective at fire suppression, they display several inefficiencies. The spray pattern, being round, does not conform conveniently to the shape of most rooms, which are generally rectangular. Thus, it is difficult to direct the spray into the corners of a room, which are typically starved of water by the round spray pattern. Furthermore, in large rooms requiring multiple sprinklers, the round spray pattern of each sprinkler is not compatible in shape with the round spray pattern of adjacent sprinklers. Adequate coverage of the room requires that the spray patterns overlap significantly, and this overlapping produces regions in the room that receive more water than required. This is wasteful of water and also requires that the sprinklers be spaced closer to one another than if the spray patterns of adjacent sprinklers were more compatible with one another in shape, requiring more sprinklers per area for adequate coverage. There is clearly a need for more efficient fire suppression sprinklers that produce an orthogonal spray pattern that distributes water more evenly to all parts of a room and is compatible in shape with adjacent spray patterns so as to avoid significant overlap of coverage between adjacent sprinklers.

### SUMMARY OF THE INVENTION

The invention concerns a sprinkler that produces an orthogonal spray pattern. The sprinkler comprises a body having an inlet adapted to attach to a conduit supplying pressurized fluid. The body also has an exit orifice in fluid communication with the inlet.

A deflector plate is mounted on the body in spaced apart facing relation to the exit orifice. A trigger mechanism is positioned between the deflector plate and the exit orifice. The trigger mechanism closes the exit orifice and prevents fluid flow therethrough. The trigger mechanism opens the exit orifice in the event of a fire condition to allow fluid to flow from the orifice and impinge on the deflector plate for dispersal of the fluid in the aforementioned orthogonal spray pattern. Preferably, the trigger mechanism is heat sensitive and opens the exit orifice when a predetermined temperature is reached.

The exit orifice has a non-round perimeter, for example a rectangular perimeter or a square perimeter. The perimeter may also comprise a plurality of lobes extending radially outwardly from an axis oriented substantially parallel to the flow of fluid through the exit orifice, or the perimeter may be defined by a plurality of interconnected convex curves.

The deflector plate may also have a perimeter with a non-round shape. The deflector plate may have a substantially rectangular perimeter, a substantially square perimeter, or the perimeter may comprise a plurality of interconnected curves, the curves for example and being concave and facing radially outwardly from an axis substantially parallel to the flow of fluid through the exit orifice. Regardless of the shape of the perimeter, the deflector plates may also include a plurality of slots extending substantially radially inwardly from the perimeter. In a preferred embodiment, the deflector plate has a perimeter with a shape that is substantially the same as the perimeter of the exit orifice. Furthermore, the body may comprise a plurality of non-round exit orifices positioned adjacent to one another. Multiple non-round exit orifices result in a spray pattern having multiple discharge axes.

### BRIEF DESCRIPTION OF THE DRAWINGS

FIG. 1 is longitudinal sectional view of a sprinkler according to the invention including a thermally activated trigger;

FIGS. 2-6 are perspective views of various different sprinkler embodiments according to the invention; and

FIG. 7 shows a plan view of an orthogonal spray pattern produce by a sprinkler according to the invention.

### DETAILED DESCRIPTION OF THE EMBODIMENTS

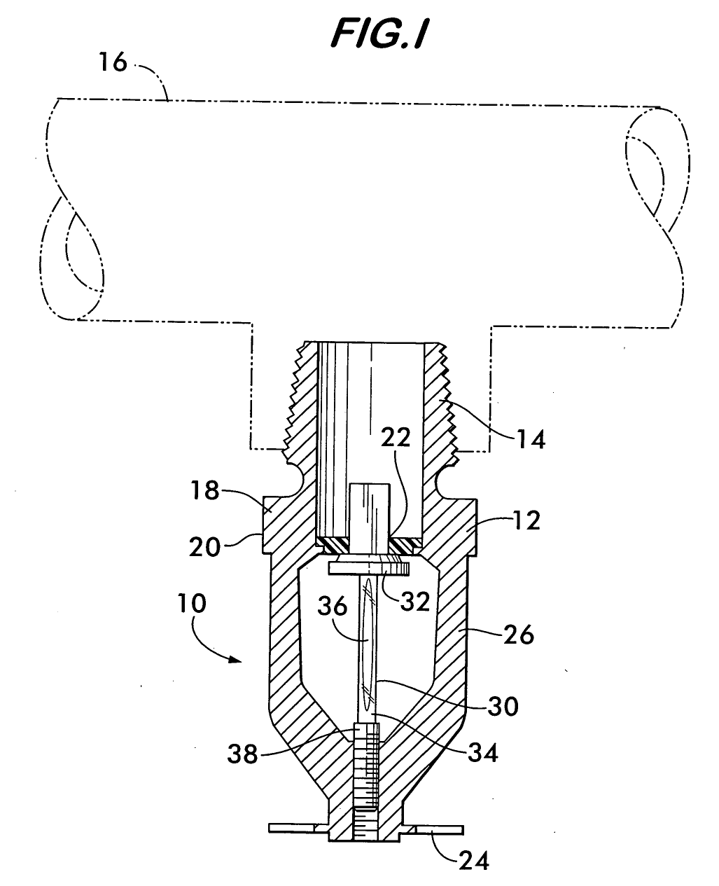

FIG. 1 shows a sprinkler 10 according to the invention. Sprinkler 10 includes a body 12 having an inlet 14 attachable to a piping network 16 in a fire suppression system. Inlet 14 is preferably threaded for convenient attachment to a compatibly threaded fitting. Body 12 has a collar 18 with flats 20 that allow a wrench to be used to tighten the sprinkler when mounting on the network.

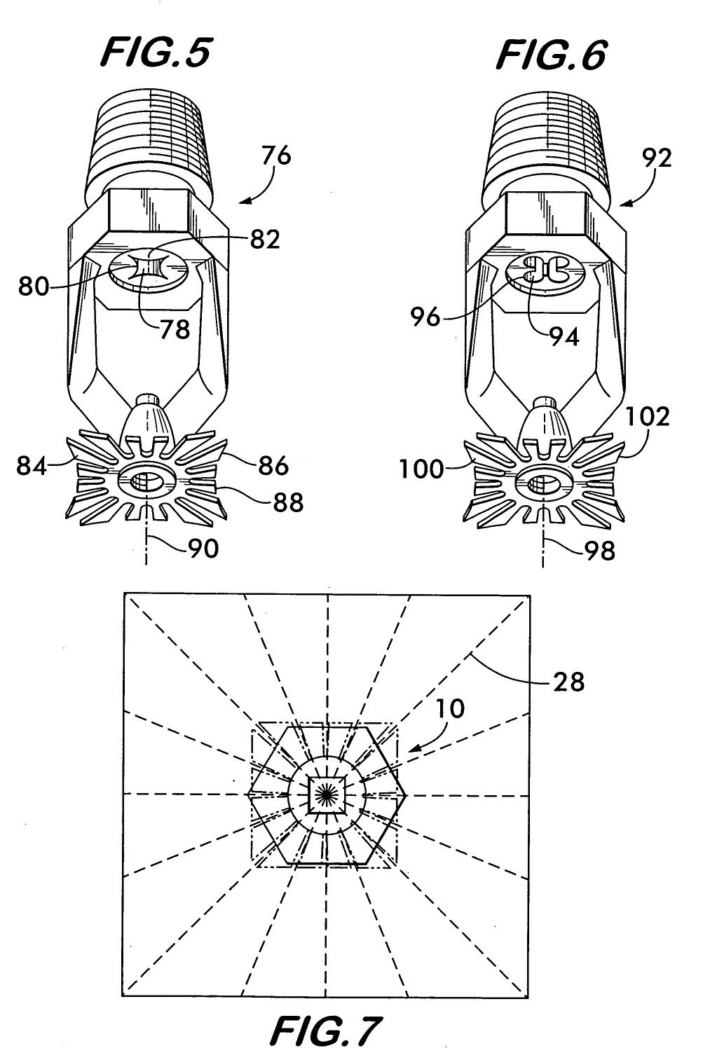

An exit orifice 22 is positioned within the body and is in fluid communication with the inlet so that water supplied to the inlet by the piping network can be discharged from the exit orifice onto a fire. A deflector plate 24 is positioned in space apart facing relation to the exit orifice. The deflector plate is mounted onto body 12 by one or more legs 26 that extend substantially axially from the body along the fluid flow path. Water discharged through the exit orifice impinges on the deflector plate and is dispersed into an orthogonal spray pattern 28 shown in FIG. 7.

Exit orifice 22 is closed to prevent discharge by a thermal trigger mechanism 30. Although many different types of trigger mechanisms exist, the mechanism shown herein by way of example is a heat sensitive trigger mechanism comprising a sealing disk 32 held seated against the exit orifice by a glass bulb 34 containing a liquid 36 that expands when subjected to heat. Glass bulb 34 is compressed between an adjustable fitting 38 and the sealing disk 32 and provides sufficient force to maintain the disk seated and sealed against fluid pressure within the piping network. In the event of a fire, the air temperature around the sprinkler rises, and when it reaches a predetermined temperature, the expansion of liquid 36 causes the bulb to break. This releases the restraining force on sealing disk 32, which disengages from the exit orifice 22 and allows water to be discharged through the sprinkler. The water impinges on the deflector plate 24 and is dispersed into the orthogonal spray pattern 28 shown in FIG. 7. Alternate trigger mechanisms include electromechanical valves actuated by a control system with sensors that detect a fire condition by sensing heat, radiant heat, combustion products, as well as other fire parameters.

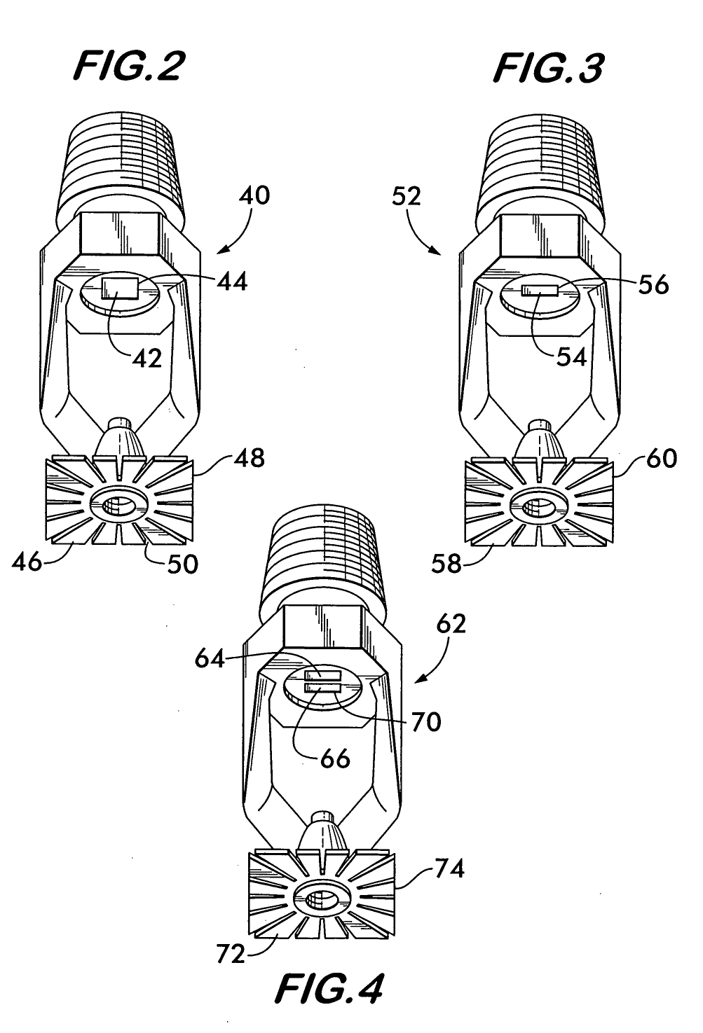

FIGS. 2-6 show various sprinkler embodiments capable of producing substantially orthogonal spray patterns. FIG. 2 shows a sprinkler 40 having an exit orifice 42 with a square perimeter 44. Sprinkler 40 also has a deflector plate 46 with a substantially square perimeter 48. Note that the term “perimeter”, when applied to the deflector plates, refers to the general shape of the plate, which may also have radially extending slots 50 which aid in the dispersal of the water stream from the exit orifice. It is found advantageous to match the perimeter shape of the deflector plate to the perimeter shape of the exit orifice. In this example, both perimeters are square. Other examples of sprinklers having matching perimeter shapes are described below.

FIG. 3 shows a sprinkler 52 having an exit orifice 54 with a rectangular perimeter 56, the deflector plate 58 in this embodiment having a substantially square perimeter 60.

The sprinkler 62, shown in FIG. 4, has a plurality of non-round orifices 64 and 66 in body 68. Orifices 64 and 66 have rectangular perimeters 70 and discharge jets of water along two discharge axes, each discharge axis substantially aligned axially with a respective orifice. The jets impinge on a deflector plate 72 having a substantially square perimeter 74. Multiple discharge axes created by multiple orifices helped distribute the water stream around the legs that support the deflector plate.

FIG. 5 shows a sprinkler 76 having an exit orifice 78 with a perimeter 80 defined by a plurality of interconnected convex curves 82. Sprinkler 76 has a deflector plate 84 having a perimeter 86 with substantially the same shape as the orifice. Perimeter 86 of plate 84 comprises a plurality of interconnected curves 88, the curves being concave and facing radially outwardly from an axis 90 substantially parallel to the flow of fluid through the exit orifice 78.

The sprinkler 92, shown in FIG. 6, has an exit orifice 94 comprising a plurality of lobes 96 that extend radially outwardly from an axis 98 oriented substantially parallel to the flow of fluid through the exit orifice. This orifice configuration discharges water substantially along four separate discharge axes, each lobe 96 defining a discharge axes aligned substantially axially with the orifice. The deflector plate 100 in this example has a perimeter 102 comprising interconnected convex curves as described above.

Sprinklers according to the invention that produce an orthogonal spray pattern provide improved efficiency over prior art sprinklers because the orthogonal spray pattern places water in all parts of a room without significant overlap with adjacent spray patterns. This feature allows for more efficient use of water as well as larger spacing between sprinklers, providing more area coverage with fewer sprinklers.

What is claimed is:

1. A sprinkler producing an orthogonal spray pattern, said sprinkler comprising:
a body having an inlet adapted to attach to a conduit supplying pressurized fluid and an exit orifice in fluid communication with said inlet, said exit orifice having a non-round perimeter; and
a deflector plate mounted on said body in spaced apart facing relation to said exit orifice, fluid flowing from said exit orifice impinging on said deflector plate and being dispersed in said orthogonal spray pattern.

2. A sprinkler according to claim 1 further comprising a trigger mechanism positioned between said deflector plate and said exit orifice, said trigger mechanism closing said exit orifice and preventing fluid flow therethrough, said trigger mechanism opening said exit orifice in the event of a fire condition to allow fluid to flow from said exit orifice and impinge on said deflector plate for dispersal of said fluid in said orthogonal spray pattern.

3. A sprinkler according to claim 2, wherein said trigger mechanism comprises a heat sensitive mechanism that opens said exit orifice when a predetermined temperature is reached.

4. A sprinkler according to claim 1, wherein said exit orifice has a rectangular perimeter.

5. A sprinkler according to claim 1, wherein said exit orifice has a square perimeter.

6. A sprinkler according to claim 1, wherein said exit orifice has a perimeter comprising a plurality of lobes extending radially outwardly from an axis oriented substantially parallel to the flow of fluid through said exit orifice.

7. A sprinkler according to claim 1, wherein said exit orifice has a perimeter defined by a plurality of interconnected convex curves.

8. A sprinkler according to claim 7, wherein said exit orifice comprises four of said convex curves.

9. A sprinkler according to claim 1, wherein said deflector plate has a perimeter having a non-round shape.

10. A sprinkler according to claim 9, wherein said deflector plate has a substantially rectangular perimeter.

11. A sprinkler according to claim 10, wherein said deflector plate has a substantially square perimeter.

12. A sprinkler according to claim 9, wherein said deflector plate has a perimeter comprising a plurality of interconnected curves.

13. A sprinkler according to claim 12, wherein said curves are concave and face radially outwardly from an axis substantially parallel to the flow of fluid through said exit orifice.

14. A sprinkler according to claim 9, further comprising a plurality of slots extending substantially radially inwardly from said perimeter.

15. A sprinkler according to claim 1, wherein said deflector plate has a perimeter with a shape that is substantially the same as the perimeter of said exit orifice.

16. A sprinkler according to claim 1, further comprising a plurality of said exit orifices positioned adjacent to one another in said body.

17. A sprinkler according to claim 16, wherein said spray pattern comprises a plurality of discharge axes.

18. A sprinkler producing an orthogonal spray pattern, said sprinkler comprising:
a body having an inlet adapted to attach to a conduit supplying pressurized fluid and an exit orifice in fluid communication with said inlet, said exit orifice having a non-round perimeter;
a deflector plate mounted on said body in spaced apart facing relation to said exit orifice, said deflector plate having a perimeter having a non-round shape; and
a heat sensitive trigger mechanism positioned between said deflector plate and said exit orifice, said trigger mechanism closing said exit orifice and preventing fluid flow therethrough, said trigger mechanism opening said exit orifice when a predetermined temperature is reached to allow fluid to flow from said orifice and impinge on said deflector plate for dispersal of said fluid in said orthogonal spray pattern.

19. A sprinkler according to claim 18, wherein said deflector plate has a perimeter with a shape that is substantially the same as the perimeter of said exit orifice.

20. A sprinkler according to claim 18, wherein said exit orifice and said deflector plate both have a substantially rectangular perimeter.

21. A sprinkler according to claim 18, wherein said exit orifice and said deflector plate both have substantially square perimeter.

22. A sprinkler according to claim 18, wherein said exit orifice and said deflector plate both have a perimeter defined by a plurality of interconnected convex curves.

23. A sprinkler according to claim 22, wherein said exit orifice perimeter comprises four of said convex curves.

24. A sprinkler producing an orthogonal spray pattern, said sprinkler comprising:
a body having an inlet adapted to attach to a conduit supplying pressurized fluid and an exit orifice in fluid communication with said inlet, said exit orifice having a perimeter shape selected from the group consisting of the shapes shown in FIGS. 2, 3, 4, 5 and 6;
a deflector plate mounted on said body in spaced apart facing relation to said exit orifice; and
a heat sensitive trigger mechanism positioned between said deflector plate and said exit orifice, said trigger mechanism closing said exit orifice and preventing fluid flow therethrough, said trigger mechanism opening said exit orifice when a predetermined temperature is reached to allow fluid to flow from said orifice and impinge on said deflector plate to produce said orthogonal spray pattern.

25. A sprinkler according to claim 24, wherein said deflector plate has a perimeter with a shape selected from the group consisting of the shapes shown in FIGS. 4 and 5.
